(19) United States
(12) Patent Application Publication
(10) Pub. No.: US 2004/0153461 A1
(43) Pub. Date: Aug. 5, 2004

(54) System and method for collecting and disseminating information

(76) Inventors: Mark L. Brown, Boise, ID (US); Vincent C. Skurdal, Boise, ID (US); Shane Gehring, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/356,991

(22) Filed: Feb. 3, 2003

(51) Int. Cl. G06F 7/00

(52) U.S. Cl. 707/100

(57) ABSTRACT

A electronic device for collecting and disseminating information is disclosed. In one embodiment, the invention is a system for collecting and disseminating a variety of information, comprising an information capture device, a storage element associated with the information capture device, a variety of information associated with the information capture device, and logic associated with the information capture device, the logic configured to organize the information into a common format and dedicated structure and allow access to the dedicated structure to obtain the information.

### BACKGROUND

Meetings are held in conference rooms around the world. During meetings, information is disseminated typically in the form of information brought to the meeting and in the form of information generated during the meeting. Information that is brought to the meeting is typically provided in the form of, for example, a printed handout, a slide presentation, or a combination of both presentation material and handout material. Unfortunately, this information must be prepared in advance and the presenter must have specific knowledge of the number of attendees to ensure that a sufficient quantity of material is prepared. Information, such as action items for individuals, reports, status, etc., that is generated during the meeting is typically captured using, for example, an electronic whiteboard, or another type information capture device. Such information is typically printed on thermal paper. Subsequently, in order to share the information, a copy of the image on the thermal paper must be made. Further, because the thermal paper is non-permanent and tends to curl, it does not provide a stable, long-term storage medium. Unfortunately, this form of information capture and dissemination is inconvenient and does not promote information sharing among the meeting attendees.

Regardless of the medium used to provide, disseminate, and capture information during a meeting, conventional systems lack the ability to allow the information to be easily and effectively captured, saved, stored and shared among the meeting attendees.

Therefore, an improved way of capturing, saving, storing and sharing information brought to and generated during a meeting is desirable.

### SUMMARY

In one embodiment, the invention is a system for collecting and disseminating a variety of information, comprising an information capture device, a storage element associated with the information capture device, a variety of information associated with the information capture device, and logic associated with the information capture device, the logic configured to organize the information into a common format and dedicated structure and allow access to the dedicated structure to obtain the information.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1 is a schematic view illustrating an exemplar environment in which the system and method for collecting and disseminating information resides.

FIG. 2 is a block diagram illustrating an embodiment of a system including the exemplary electronic device of FIG. 1.

FIG. 3 is a block diagram illustrating an embodiment of the electronic device of FIG. 2.

FIG. 4 is a flow chart illustrating an example of the operation of the information management software of FIG. 2.

### DETAILED DESCRIPTION

The system and method for collecting and dissemination information is described below in the context of an “all-in-one” device. However, the system and method for collecting and disseminating information can be implemented using other electronic devices. The system and method for collecting and dissemination information is also described below as being particularly useful during a meeting attended by a number of individuals during which a variety of information is presented. However, the system and method for collecting and disseminating information is not limited to use during meetings and can be used to collect and disseminate information in other situations and applications.

The system and method for collecting and disseminating information can be implemented in software (e.g., firmware), hardware, or a combination thereof. In one embodiment, the system and method for collecting and disseminating information is implemented using a combination of hardware and software.

Regardless of the manner of implementation, the software portion of the system and method for collecting and disseminating information can be executed by a special or general-purpose computer, such as a personal computer, workstation, minicomputer, or mainframe computer.

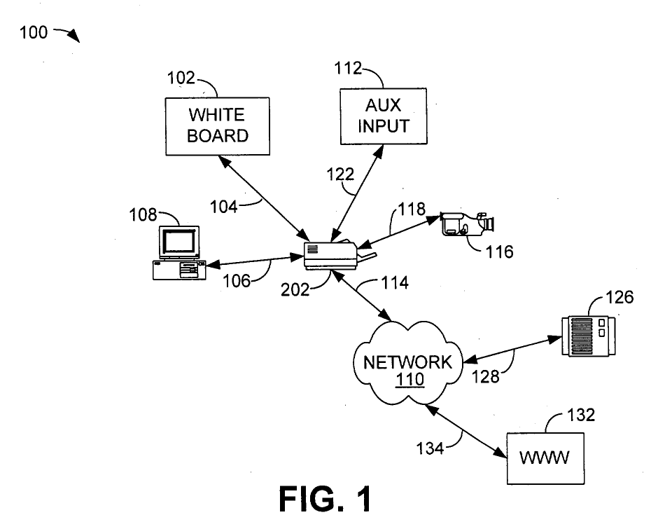

FIG. 1 is a schematic view illustrating an exemplary environment 100 in which the system and method for collecting and disseminating information resides. As mentioned above, in one embodiment, the system and method for collecting and disseminating information is implemented in hardware and software using an electronic device 202. In this example, the electronic device 202 can be what is referred to as an “all-in-one” device. Such a device is capable of performing a variety of documents processing functions. For example, the electronic device 202 can be an electronic device that can, for example, print, copy, fax, and scan documents.

The electronic device 202 can be coupled to a network 110 via connection 114. The network 110 can be a local area network (LAN) or a wide area network (WAN). For example, the network 110 can be a company network, such as an Intranet, or can be the world wide web (WWW) accessed via the Internet. To illustrate two possible networked examples, the environment 100 includes a server 126 coupled to the network 110 via connection 128, and includes a WWW location 132 coupled to the network 110 via connection 134. The server 126 and the WWW location 132 are shown for illustration only. If coupled to the network 110, the electronic device 202 will include a network interface. Further, if the electronic device 202 is a so-called “web enabled” device, then the electronic device 202 will also include an integrated web server.

In accordance with an aspect of the invention, the electronic device 202 can be located in or near a conference room in which a number of individuals are attending a meeting. Typically, when a meeting is to occur, material may be provided to the attendees, either in advance, or provided at the meeting. Such information may be, for example, a paper copy of a presentation, a handout, or other multi-media material. Further, during the meeting, information will likely be produced. For example, in a technical meeting, there is frequently a “white board” present, on which drawings, sketches, or meeting notes may be written. Further, such a white board may be an electronic device that can print the contents of the board before the board is erased. Further, scanned text, electronic text, a digital photograph, voice, or any other type of information can be generated. In such a meeting environment, it would be desirable to have a repository for all the information that is brought to, or generated at the meeting. Further, it would be desirable to make that information available to the attendees in a number of different ways. As will be described in detail below, the electronic device 202 can be used to collect, store, and make available, both locally and via a network, all of the information associated with a meeting.

In accordance with this aspect of the system and method for collecting and disseminating information, the environment 100 may comprise a variety of different devices that can be used to generate information and deliver the information to the electronic device 202. In this example, the environment 100 includes a computer 108 coupled to the electronic device 202 via connection 106, a white board 102 coupled to the electronic device 202 via connection 104, a digital camera 116 coupled to the electronic device 202 via connection 118, and an auxiliary input device 112 coupled to the electronic device 202 via connection 122. The auxiliary input device 112 may include, for example, a microphone to record verbal exchanges during the meeting, or a memory card receptacle configured to receive a memory card from a digital camera. For example, the memory card receptacle may be configured to receive a memory card such as a Smart Media® card, a CompactFlash® memory card, or any other memory card or removable memory media.

The electronic device 202 can accept a variety of information from a variety of input sources and convert the information to a common format. The information is then made available to the attendees of the meeting. The information can be made available to the attendees of the meeting via, for example, a hard printout of the information directly from the electronic device 202.

Alternatively, the information can be stored on the electronic device 202 in a dedicated structure and in an electronic file structure so that an individual via the network 110 can access the information. In another alternative implementation, the information can be stored on the server 126 and accessed by a user of the system. In yet another alternative implementation, the information can be stored on a storage device (not shown) that is accessible via the WWW using, for example, a uniform resource locator (URL). In such an implementation, the attendees of the meeting at which the information is collected need not be in the same physical location.

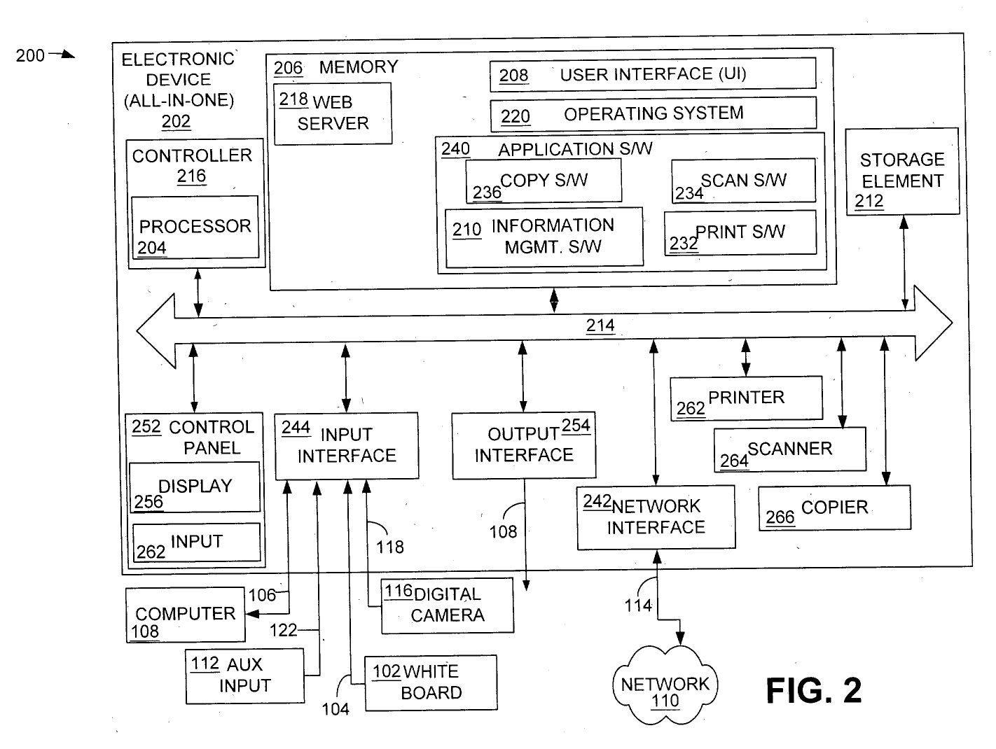

FIG. 2 is a block diagram illustrating a system 200 including the exemplary electronic device 202 of FIG. 1. The electronic device 202 can include a software element referred to as the information management software 210. The information management software 210 and other software and hardware elements (to be discussed with respect to FIG. 2) work in unison to implement the functionality of the invention.

Generally, in terms of hardware architecture, as shown in FIG. 2, the electronic device 202 includes a controller 216, which further includes a processor 204, a memory 206, a storage element 212, a control panel 252, an input interface 244 and an output interface 254 that are connected together and can communicate with each other via a local interface 214. The local interface 214 can be, for example but not limited to, one or more buses or other wired or wireless connections, as is known to those having ordinary skill in the art. The local interface 214 may have additional elements, which are omitted for simplicity, such as buffers (caches), drivers, and controllers, to enable communications. Further, the local interface 214 includes address, control, and data connections to enable appropriate communications among the above-mentioned components.

When implemented as an all-in-one device, the electronic device 202 also comprises a printer 262, a scanner 264 and a copier 266. The printer 262, scanner 264 and copier 266 provide their respective functionality in accordance with corresponding software elements 232, 234 and 236, which are application level software components and which reside in the memory 206. The functionality of the electronic device 202 is controlled via the control panel 252. The control panel generally includes an input element 262 and a display 256. The input element 262 may include buttons, a touch pad, or any other element for communicating control inputs to the electronic device 202. The display 256 may be, for example, a liquid crystal display (LCD) element for displaying status of the electronic device 202.

The controller 216 controls the operation of the electronic device 202 via the processor 204. The processor 204 is a hardware device for executing software that can be stored in memory 206. The processor 204 can be any custom made or commercially available processor, a central processing unit (CPU) or an auxiliary processor among several processors associated with the electronic device 202, and a microchip-based microprocessor or a macroprocessor.

The memory 206 can include any one or combination of volatile memory elements and nonvolatile memory elements. Moreover, the memory 206 may incorporate electronic, magnetic, optical, and/or other types of storage media. Note that the memory 206 can have a distributed architecture, where various components are situated remote from one another, but can be accessed by the processor 204.

The input interface 244 can receive information from, for example, the computer 108, the white board 112, the digital camera 116 or via the auxiliary input element 112 of FIG. 1.

The output interface 254 sends commands via connection 108 to devices external to the electronic device 202. The network interface 242, which can be, for example, a network interface card (NIC) located in the electronic device 202 or a modulator/demodulator (modem), can be any communication device capable of connecting the electronic device 202 to an external network 110.

The software in memory 206 may include one or more separate programs, each of which comprises an ordered listing of executable instructions for implementing logical functions. In the example of FIG. 2, the software in the memory 206 includes the information management software 210, a user interface (UI) 208, which works in cooperation with the control panel 252, a web server 218, application software 240 and a suitable operating system (O/S) 220. The information management software 210 can be implemented as application level software. The print software 232, scan software 234 and the copy software 236 are also application level software components that work in cooperation with the printer 262, scanner 264 and the copier 266, respectively, to perform those respective functions.

The operating system 220 can be any available operating system that can control the operation of the electronic device 202. The operating system 220 essentially controls the execution of other computer programs, such as the information management software 210 and the application software 240, and provides scheduling, input-output control, file and data management, memory management, and communication control and related services. The processor 204 and operating system 220 define a processing platform, for which application programs, such as the information management software 210 and the application software 240 are executed. The information management software 210 includes the software that allows the electronic device 202 to collect, store and disseminate a variety of information acquired from a variety of sources.

When the electronic device 202 is in operation, the processor 204 is configured to execute software stored within the memory 206, to communicate data to and from the memory 204 and to generally control operations of the electronic device 202 pursuant to the software. The information management software 210 and the O/S 220, in whole or in part, but typically the latter, are read by the processor 204, perhaps buffered within the processor 204, and then executed.

The portions of the system and method for collecting and disseminating information that are implemented in software can be stored on any computer-readable medium for use by or in connection with any computer related system or method. In the context of this document, a computer-readable medium is an electronic, magnetic, optical, or other physical device or means that can contain or store a computer program for use by or in connection with a computer related system or method. The information management software 210 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The hardware components of the system and method for collecting and disseminating information can be implemented with any or a combination of the following technologies, which are each well known in the art: a discrete logic circuit(s) having logic gates for implementing logic functions upon data signals, an application specific integrated circuit (ASIC) having appropriate logic gates, a programmable gate array(s) (PGA), a field programmable gate array (FPGA), etc.

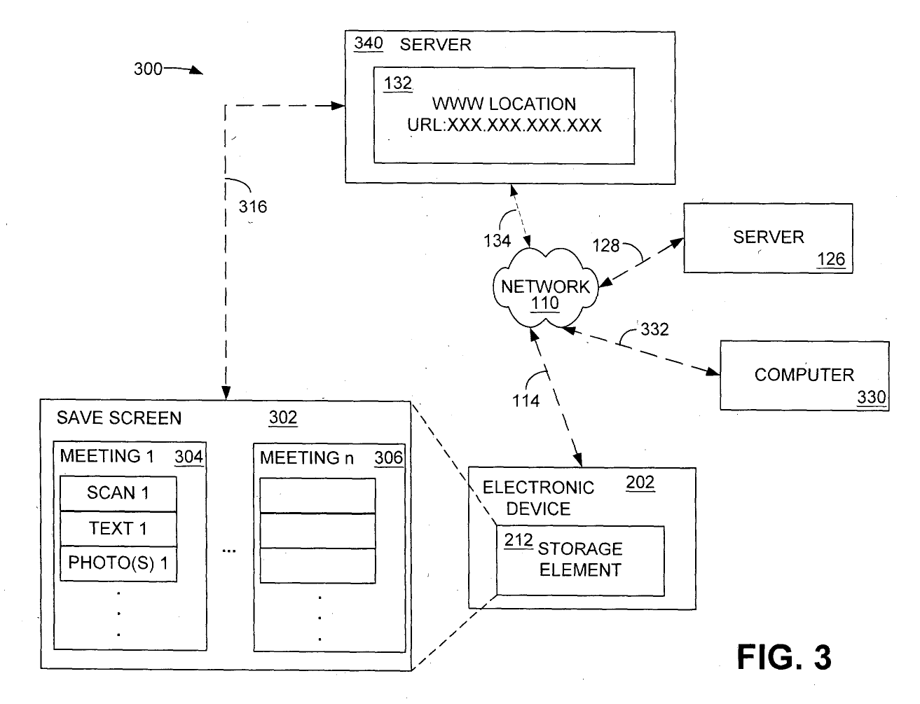

FIG. 3 is a block diagram 300 illustrating an embodiment of the electronic device 202 of FIG. 2. The electronic device 202 is coupled to the network 110 via connection 114. Further, a computer, such as a personal computer (PC) 330, is coupled to the network 110 via connection 332. Similarly, the server 126 is coupled to the network 110 via connection 128 and the server 340 is coupled to the network 110 via connection 134. The server 340 maintains the world wide web location 132, and is generally referred to as a “web server.” Alternatively, if web enabled, the electronic device 202 may maintain a WWW location (a domain name server (DNS).

The electronic device 202 includes storage element 212. In this example, the storage element 212 is the location in which the variety of information gathered during the meeting, as described above, is stored. For example, during, or at the end of a meeting in which a variety of information is generated (FIG. 1), a menu, such as a save screen menu 302, can be displayed to a user of the electronic device 202 via the display 256 (FIG. 2). The save screen menu 302 includes one or more reference tags that can be illustrated as, for example, meeting folders. The meeting folders are structures dedicated to organizing and storing the variety of information that is brought to and generated during a meeting.

Exemplary meeting folders are illustrated as meeting folder 1 304 and meeting folder n 306. It should be mentioned that any number of meeting subfolders can also be created during the meeting to save the various types information generated during a meeting. Generally, each meeting will have a unique top level folder, such as meeting folder 1 304 with which it is associated, and one more sub folders.

In the example shown in FIG. 3, the meeting folder 1 304 includes subfolders for a first scan, a first text element, and a first photograph. Other types of information can also be saved in the meeting folder 1 304. In accordance with this aspect of the invention, all of the information brought to and generated during the meeting is input into the electronic device 202, converted to a common format, such as, for example, a portable document format (.pdf), and stored in the storage element 212. Using this example, at the end of the meeting, all of the information stored in the storage element 212 can be, for example, printed and provided to the meeting attendees.

However, in alternative embodiments, the information saved in a meeting folder can be stored elsewhere than on the electronic device 202. For example, the folder can be saved on the server 126, or can be saved on the server 340 associated with the world wide web location 132.

In such an example, a remotely located user, such as an individual using the computer 330 via the network 110, can access the meeting folders (304, 306), and associated subfolders, via the network 110. In this manner, the information that is generated during a meeting can be saved, stored and made available remotely via the network 110.

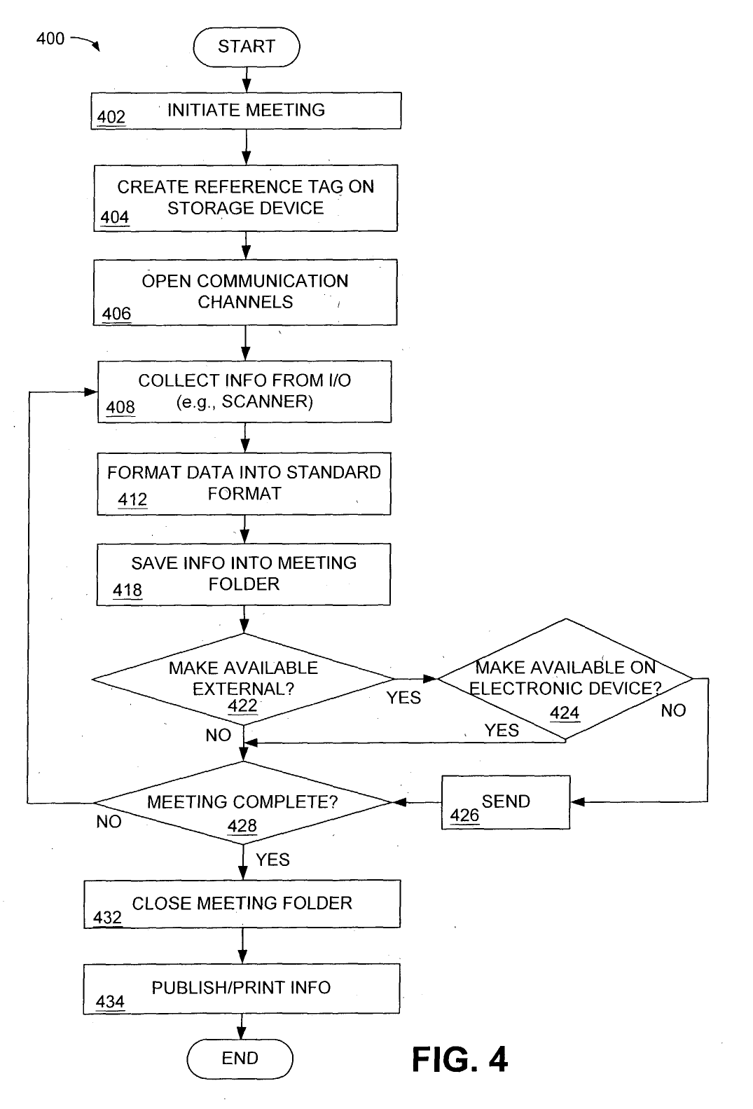

FIG. 4 is a flow chart 400 illustrating an example of the operation of the information management software 210 of FIG. 2. Any process descriptions or blocks in flow charts should be understood as representing modules, segments, or portions of code which include one or more executable instructions for implementing specific logical functions or steps in the process, and alternative implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention. Further, different types of data, such as scan data, text data, photo data, and email data, etc., can be interleaved in any order.

In block 402 a meeting is initiated by, for example, using the control panel 252 to activate and initialize the electronic device 202 (FIG. 2). In block 404, a reference tag is created and applied to a meeting folder, such as the meeting folder 1 304 of FIG. 3. The meeting folder is associated with the electronic device 202. As described above, the reference tag can be created in the storage element 212 of the electronic device 202, or can be created elsewhere and accessed via the network 110, as described above.

In block 406 the controller 216 opens the communication channels via the input interface 244 (FIG. 2) to receive information from, for example, the computer 108, the white board 102, the digital camera 116, the auxiliary input element 112, or any other device coupled to the electronic device 202.

In block 408, information is collected from the devices coupled to the electronic device 202. For example, if a hard copy of text is brought to the meeting, the scanner 264 in the electronic device 202 could scan the hard copy. In this example, the scanner 264 is an alternative input source and is coupled to the input interface 244 via the local interface 214. In block 412, the data received from the scanner 264 is formatted by the information management software 210 into a standard format, such as .pdf, and saved in the storage element 212.

In block 418, the information from the scanner 264 obtained in block 412 is saved into, for example, a text subfolder associated with the meeting folder 1 304 (FIG. 3). In block 422 it is determined whether the information saved in the meeting folder 1 304 is to be made available external to the electronic device 202. If it is determined in block 422 that the saved information is to be made available externally. In block 424 it is determined whether the information will be made externally available directly from the electronic device 202. If the information is to be made available from the electronic device 202, then an individual desiring access to the information can access the information via the web server 218 associated with the electronic device 202. Alternatively, the information can be transferred from the electronic device 202 to a remote location. In this example, in block 426, the information is forwarded from the electronic device 202, via the network interface 242, onto the network 110 to a remote destination. The remote destination may be, for example, the server 126 or the server 340 of FIG. 3. The process then proceeds to block 428.

If, in block 422, it is determined that the information saved in the storage element 212 is not to be made available external to the electronic device 202, then, in block 428 it is determined whether the meeting is complete. If the meeting is not yet complete, then the process returns to block 408.

If, in block 428 it is determined that the meeting is complete, then, in block 432, the meeting folder 1 304 is closed by entering appropriate commands into the control panel 252 of FIG. 2. In block 434, the information saved in the meeting folder 1 304 can be printed via the printer 262 and distributed to the meeting attendees, or, as described above, can be published and made available via the network 110. In the case of captured audio information, a transcript can be created and printed. Alternatively, the information management software 210 can create a uniform resource locator that identifies a world wide web location (132 of FIG. 3) at which the meeting folder 1 304, or a copy of the meeting folder, is located. The world wide web location 132 can then be accessed remotely using, for example, the computer 330 via the network 110. In this manner, all information obtained and saved by the electronic device 202 can be made available to meeting attendees, regardless of whether they are in the same physical location as the electronic device 202.

It will be apparent to those skilled in the art that many modifications and variations may be made to the preferred embodiments of the present invention, as set forth above, without departing substantially from the principles of the present invention. For example, the system and method for collecting and disseminating information can be used to store information locally on an electronic device that may be accessed locally or via a network, or can be used to store information at a remote location that can be accessed via a network. All such modifications and variations are intended to be included herein within the scope of the present invention, as defined in the claims that follow.

What is claimed is:

1. A system for collecting and disseminating a variety of information, comprising:
an information capture device;
a storage element associated with the information capture device;
a variety of information associated with the information capture device; and
logic associated with the information capture device, the logic configured to organize the information into a common format and dedicated structure and allow access to the dedicated structure to obtain the information.

2. The system of claim 1, wherein the dedicated structure is an electronic file structure that is electronically accessible.

3. The system of claim 2, further comprising:
a network to which the information capture device is coupled; and
wherein the electronic file structure is accessible over the network.

4. The system of claim 3, wherein the electronic file structure is accessible via the world wide web (WWW).

5. The system of claim 3, wherein the electronic file structure is simultaneously accessible to a plurality of individuals coupled to the information capture device via the network.

6. The system of claim 4, wherein the variety of information comprises information that is generated during a meeting and the logic further comprises:
a tag associated with the meeting and the electronic file structure; and
a memory associated with the information capture device, the memory configured to store the electronic file structure under the tag.

7. The system of claim 1, wherein the information capture device comprises a combined printer, copier and scanner.

8. The system of claim 7, wherein the variety of information is chosen from the group consisting of scanned text, electronic text, a digital photograph and voice.

9. The system of claim 8, wherein the information capture device makes the variety of information available in a common format.

10. A method for collecting and disseminating a variety of information, comprising:
providing a variety of information to an information capture device;
storing the information in a memory associated with the information capture device;
organizing the information into a common format and dedicated structure; and
allowing access to the dedicated structure to obtain the information.

11. The method of claim 10, wherein the dedicated structure is an electronic file structure that is electronically accessible.

12. The method of claim 11, further comprising:
coupling the information capture device to a network; and
accessing the electronic file structure over the network.

13. The method of claim 12, further comprising accessing the electronic file structure via the world wide web (WWW).

14. The method of claim 12, further comprising simultaneously accessing the electronic file structure by a plurality of individuals coupled to the information capture device via the network.

15. The method of claim 13, further comprising:
generating the variety of information during a meeting;
associating a tag with the meeting and the electronic file structure;
associating a memory with the information capture device; and
storing the electronic file structure in the memory and under the tag.

16. The method of claim 10, wherein the information capture device comprises a combined printer, copier and scanner.

17. The method of claim 16, wherein the variety of information is chosen from the group consisting of scanned text, electronic text, a digital photograph and voice.

18. The method of claim 17, further comprising making the variety of information available in a common format.

19. A system for collecting and disseminating a variety of information during a meeting, comprising:
means for providing a variety of information to an information capture device;
means for storing the information in a memory associated with the information capture device;
means for organizing the information into a common format and dedicated structure; and
means for allowing access to the dedicated structure to obtain the information.

20. The system of claim 19, wherein the dedicated structure is an electronic file structure that is electronically accessible.
